(19) United States
(12) Patent Application Publication
(10) Pub. No.: US 2006/0097625 A1
(43) Pub. Date: May 11, 2006

(54) Low voltage electron excited white lighting device

(75) Inventors: Chia-Chen Kang, Taipei City (TW); Ru-Shi Liu, Zhudong Town (TW); Whe-Yi Chiang, Hsinchu City (TW)

Correspondence Address: ROSENBERG, KLEIN & LEE, 3458 ELLICOTT CENTER DRIVE-SUITE 101, ELLICOTT CITY, MD, 21043, US

(73) Assignee: Taiwan Thick-Film Ind. Corp.

(21) Appl. No.: 10/982,437

(22) Filed: Nov. 5, 2004

(51) Int. Cl. H01J 1/62; H01J 63/04

(52) U.S. Cl. 313/503

(57) ABSTRACT

The present invention discloses a low voltage electron excited white lighting device, which comprises a low voltage exciting source and at least two fluorescent substances exhibiting yellow and blue luminous colors after excited by the low voltage exciting source. The host lattice of at least two fluorescent substances is composed of alkaline earth metal and aluminium oxide, and the host lattice is further doped with activator. Furthermore, the fluorescent substance(s) exhibiting yellow luminous color is (Y₃₋ₓCeₓ)Al₅O₁₂ (0.0001 [symbol] × [symbol] 0.5), and the one(s) exhibiting blue luminous color is (Ba₁₋ₓEuₓ)MgAl₁₀O₁₇ (0.0001 [symbol] × [symbol] 0.5). By mixing generated yellow and blue lights, white light is then obtained. Besides, (Y₃₋ₓCeₓ)Al₅O₁₂ (0.0001 [symbol] × [symbol] 0.5) further absorbs a part of the blue ray emitted from (Ba₁₋ₓEuₓ)MgAl₁₀O₁₇ (0.0001 [symbol] × [symbol] 0.5), to thereby emit yellow ray, such that more stronger white light can be obtained. This invention has advantages of forming saturated colors, high reliability, etc. Additionally, the provided fluorescent substances with single phase can be fabricated in a variety of methods, such as solid state reaction method, co-precipitation method, gel method and micro emulsion method. To sum up, the fabricating method disclosed in this invention is simple, suitable for high throughput and has economic effects in industries.

### BACKGROUND OF THE INVENTION

1. Field of the Invention

The present invention is generally related to white lighting device, and more particularly to a low voltage electron excited white lighting device which can be applied in field emission display.

2. Description of the Prior Art

The global market for flat panel displays (FPDs) was estimated at 18.5 billion dollars in sales in 1999, and the market is predicted to reach $70 billion by the year 2010. The tremendous growth in FPD popularity is due largely to the improvements in quality and cost reduction of liquid crystal displays (LCDs). Other types of FPDs are also increasingly finding their way to the customer showrooms. These include plasma and projection displays, aimed at the high end, large area home entertainment and commercial display systems, as well as organic light emitting displays, with high-volume mass market applications in cell phones, personal digital assistant (PDA), vehicle information processor (VIP) and digital cameras. For reasons of weight, volume and health, the marker share of FPDs are getting higher and higher. Given the magnitude and growth potential of the display market, it is not surprising that alternative FPD technologies continue to attract investment because they hold the promise of surpassing LCDs in price, performance, and scalability. One of the attractive technologies is field emission display (FED). The FED is a vacuum electron device, sharing many common features with the cathode-ray tube (CRT). In a FED the electron source consists of a matrix-addressed array of millions of cold emitters. This field emission array (FEA) is placed in close proximity (0.2-2.0 mm) to a phosphor faceplate and is aligned such that each phosphor pixel has a dedicated set of field emitters. Although FED is very similar to a thin CRT in appearance, the operational potential of FED is much lower (≦1 kV) than CRT (15-30 kV).

The first operating FEAs were demonstrated by Capp Spitindt. He successfully applied semiconductor based manufacturing methods to fabricating arrays of micron-sized, self-aligned metal cones, each surrounded by a metal gate (called Spindt-type emitter). Despite the many advantages of the Spindt-type FEA fabrication technique, scaling this method to large area substrate (>400 mm on the side) is still a major challenge. Additionally, the Spindt tips are easy worn down, which results in a consequent shorter lifetime. Graphite with naro-structure or carbon nanotube has been found suitable to be used as field emitters because of their low turn-on potential. Currently, carbon nanotube field emission display (CNT-FED) has attracted great interest on research.

On the other hand, another important issue in FED is fluorescent substance which is able to decide the colors and luminous efficiency of the FED. Researches in this field are still in their initial stages. Since 1998, Samsung has applied numbers of patents about fluorescent substances and claimed high luminous efficiency thereof, these fluorescent substances include ZnS, (Zn, Cd)S, ZnS: Zn, ZnS: Ag, [(Zn,Cd)S: Ag, Cl], ZnGa₂O₄, ZnGa₂O₄: Bi, SrTiO₃: RE and Y₂SiO₅ based compounds. (such as: U.S. Pat. No. 5,068,157, U.S. Pat. No. 6,152,965, U.S. Pat. No. 6,322,725, U.S. Pat. No. 6,416,688, U.S. Pat. No. 6,440,329, U.S. Pat. No. 6,641,756, US2003197460, EP0882776, EP1052276 and FR2800509). Additionally, Futaba Denshi Koggo (Japan) also applied several patents about low voltage fluorescent substances, these fluorescent substances include SrTiO₃: Pr, [ZnGa₂O₄: Li, P], [(Zn,Cd)S: Ag, Cl] and La₂O₂S: RE based compounds.

At present, most commercial FED utilizes P22-type fluorescent substances, wherein the blue fluorescent substance is (ZnS: Ag, Cl), the green fluorescent substance is (ZnS: Cu, Au, Al) and the red fluorescent substance is Y₂O₂S: Eu. The most common application of the P22-type fluorescent substances is for CRT displays, and when being used for CRT displays, the P22-type fluorescent substances are covered with an aluminium layer. However, when being used for FED the P22-type fluorescent substances are not covered with the aluminium layer, in order to keep a low working voltage. Therefore, lifetime of FED will be dramatically reduced because of deterioration of fluorescent substances, contamination of cathode and reduction of vacuum degree. Most of P22-type fluorescent substances are sulfide-based, they are less adaptive to environmental variations than oxide-based fluorescent substances. This makes the P22-type fluorescent substances less stable than those oxide-based fluorescent substances. Further, efficiency of luminescence of the P22-type fluorescent substances is reduced in an FED driven by low voltage.

### SUMMARY OF THE INVENTION

In accordance with the present invention, new low voltage electron excited white lighting device is provided. The white lighting device can meet the requirement of high luminous efficiency and high reliability, so as to be applied in FED industries. One object of the present invention is to disclose a whit lighting device comprising an exciting source and at least two fluorescent substances exhibiting yellow and blue luminous colors, wherein the host lattice of at least two fluorescent substances is composed of alkaline earth metal and aluminium oxide, and the host lattice is further doped with activator. By mixing generated yellow and blue lights, white light is then obtained. Another object of the present invention is to provide an oxide-based fluorescent substance which imparts, comparing to sulfide-based fluorescent substances, more stable structure, more saturated colors, and higher luminous efficiency. Moreover, the oxide-based fluorescent substances provided in the present invention can be applied as phototubes excited by electrons or plasma or light source emitting fluorescence.

### BRIEF DESCRIPTION OF THE DRAWINGS

FIG. 1 is a emittion spectrum of (Y_{2.95}Ce_{0.05})Al₅O₁₂ in accordance with a preferred embodiment of this present invention;

FIG. 2 is a emittion spectrum of (Ba_{0.9}Eu_{0.1})MgAl₁₀O₁₇ in accordance with a preferred embodiment of this present invention;

FIG. 3 is a emittion spectrum of the white lighting formula which is composed of (Y_{2.95}Ce_{0.05})Al₅O₁₂ and (Ba_{0.9}Eu_{0.1})MgAl₁₀O₁₇ with proper portions in accordance with a preferred embodiment of this present invention; and

FIG. 4 is a CIE chromaticity diagram illustrating the transformed coordinates of original emittion spectrums of FIG. 1, FIG. 2 and FIG. 3, respectively.

### DESCRIPTION OF THE PREFERRED EMBODIMENTS

What is probed into the invention is low voltage electron excited white lighting device. Detailed descriptions of the production, structure and elements will be provided in the following in order to make the invention thoroughly understood. Obviously, the application of the invention is not confined to specific details familiar to those who are skilled in the white lighting device. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a preferred embodiment of this invention, there is provided a white lighting device which comprises a low voltage exciting source and at least two fluorescent substances, wherein the low voltage exciting source is selected from a group consisting of the following: carbon nanotube emitter (CNT), surface conduction electron emitter (SED), ballistic electron surface emitter (BSD), metal insulator metal emitter (MIM) and the modifications thereof, and the working voltage of the low voltage exciting source is equal to or less than 1 kV. On the other hand, at least two fluorescent substances exhibit yellow and blue luminous colors after excited by the low voltage exciting source, wherein the host lattice of at least two fluorescent substances is composed of alkaline earth metal and aluminium oxide, and the host lattice is further doped with activator. Moreover, the fluorescent substance exhibiting yellow luminous color is (Y₃₋ₓCeₓ)Al₅O₁₂ (0.0001 [symbol] × [symbol] 0.5), and said fluorescent substance exhibiting blue luminous color is (Ba₁₋ₓEuₓ)MgAl₁₀O₁₇ (0.0001 [symbol] × [symbol] 0.5). By mixing generated yellow and blue lights, a white light is then obtained; in addition, the fluorescent substance exhibiting yellow color further absorbs a part of the blue ray emitted from the fluorescent substance exhibiting blue color, in an effort to obtain a stronger white light. Furthermore, a preferred fluorescent substance exhibiting yellow luminous color is (Y_{2.95}Ce_{0.05})Al₅O₁₂, and a preferred fluorescent substance exhibiting blue luminous color is (Ba_{0.9}Eu_{0.1})MgAl₁₀O₁₇.

In this embodiment, a method for producing (Y₃₋ₓCeₓ)Al₅O₁₂ (0.0001 [symbol] × [symbol] 0.5) is disclosed. First, nitrates of yttrium, aluminum and cerium or oxides of yttrium, aluminum and cerium according to the wanted molar ratio in (Y₃₋ₓCeₓ)Al₅O₁₂ (0.001 [symbol] × [symbol] 0.5) are mixed and a first mixture is formed, wherein the nitrates of yttrium, aluminum and cerium comprise Y(NO₃)₃ [symbol] 6H₂O, Al(NO₃)₃.9H₂O and Ce(NO₃)₃ [symbol] 6Next, at a first temperature a calcination process is performed to calcine the first mixture in the air, so as to form a second mixture, wherein the first temperature is lower than 1100 [symbol] and the operating time of the calcination process ranges from 20 to 30 hours. Then, at a second temperature a sintering process is performed to sinter the second mixture in the air, so as to form a third mixture, wherein the second temperature ranges from 1200 [symbol] to 1700 [symbol] and the operating time of said sintering process ranges from 20 to 30 hours. Finally, at a third temperature a first reduction process is performed to reduce the third mixture, so as to form the (Y₃₋ₓCeₓ)Al₅O₁₂(0.0001 [symbol] × [symbol] 0.5), wherein the third temperature ranges from 1200 [symbol] to 1700 [symbol] , and 1500 [symbol] is preferred. The operating time of the first reduction process ranges from 4 to 24 hours, and 12 hours are preferred. Additionally, the environment for the reduction process comprises mixed hydrogen and nitrogen or mixed hydrogen and argon.

### EXAMPLE 1

5.2923 g of Y(NO₃)₃ [symbol] 6H₂O, 8.6400 g of Al(NO₃)₃.9H₂O and 0.1000 g of Ce(NO₃)₃ [symbol] 6H₂O are well mixed to form a first mixture. [according to the molar ratio in (Y_{2.95}Ce_{0.05})Al₅O₁₂]. Next, the first mixture is milled and placed in a container made of aluminium oxide, and the first mixture is heated with a rate of 5 [symbol] per minute (5 [symbol] /min) until the temperature reaches 1000 [symbol] . Then, a calcination process is performed to calcine the first mixture in the air for 24 hours, so as to form a second mixture. After the calcination process, the second mixture is cooled with a rate of 5 [symbol] per minute (5 [symbol] /min) until the temperature of the second mixture reaches room temperature. The above-mentioned heating rate and cooling rate are kept the same in the following procedures. Next, the cooled second mixture is also milled and placed in a container made of aluminium oxide. Then, the second mixture is heated to 1500 [symbol] , and a sintering process is performed to sinter the second mixture in the air for 24 hours, so as to form a third mixture. After the sintering process, the third mixture is cooled to room temperature. Next, the cooled third mixture is also milled and placed in a container made of aluminium oxide. Then, in an environment comprises mixed hydrogen and nitrogen or mixed hydrogen and argon, the third mixture is heated to 1500 [symbol] , and a reduction process is performed to reduce the third mixture in the same environment for 24 hours, so as to form (Y_{2.95}Ce_{0.05})Al₅O₁₂. After the reduction process, (Y_{2.95}Ce_{0.05})Al₅O₁₂ is cooled to room temperature. Finally, (Y_{2.95}Ce_{0.05})Al₅O₁₂ is milled so as to obtain particles with uniformly size distribution.

In this embodiment, the method for producing (Y₃₋ₓCeₓ)Al₅O₁₂ (0.0001 [symbol] × [symbol] 0.5), before the calcination process, further comprises: dissolving the first mixture into an aqueous solution and forming a first solution; adding a chelating agent to the first solution to chelate with metal ions and forming a second solution, wherein the chelating agent further comprises citric acid; adding a alkaline compound to the second solution and forming a third solution, wherein the alkaline compound is to adjust the pH value of the third solution. The alkaline compound further comprises ethylenediamine, and the pH value of the third solution ranges from pH 5 to pH 10, wherein pH 7 is preferred; heating the third solution until it becomes sticky; at a fourth temperature performing a first pyrolysis process to remove most organic matters and a part of nitrogen oxides from the sticky third solution, so as to form a first solid matter for next calcination process, wherein the fourth temperature ranges from 450 [symbol] to 600 [symbol] .

On the other hand, in this embodiment, the method for producing (Y₃₋ₓCeₓ)Al₅O₁₂ (0.0001 [symbol] × [symbol] 0.5), before the calcination process, further comprises: dissolving the first mixture into an aqueous solution and forming a fourth solution; adding a alkaline compound to the fourth solution and forming a sixth solution, wherein the alkaline compound further comprises triethylamine. The alkaline compound is to adjust the pH value of the sixth solution, so as to produce a white gel, wherein the pH value of the sixth solution ranges from pH 3 to pH 11, and pH 10 to pH 11 is preferred; performing a vacuum filtration process to proceed the sixth solution and obtaining the white gel; and at a fifth temperature performing a second pyrolysis process to remove most organic matters and a part of nitrogen oxides from the white, so as to form a second solid matter for next calcination process, wherein the fifth temperature ranges from 450 [symbol] to 600 [symbol] .

In this embodiment, a method for producing (Ba₁₋ₓEuₓ) MgAl₁₀O₁₇ (0.0001 [symbol] × [symbol] 0.5) is disclosed. First, oxides of barium, europium, magnesium and aluminum are mixed according to the wanted molar ratio in (Ba₁₋ₓEuₓ)MgAl₁₀O₁₇ (0.0001 [symbol] × [symbol] 0.5) and a mixture is formed, wherein the oxides of barium, europium, magnesium and aluminum comprise BaO, Eu₂O₃, MgO and Al₂O₃. Next, at a sixth temperature a second reduction process is performed to reduce the mixture, so as to form the (Ba₁₋ₓEuₓ)MgAl₁₀O₁₇ (0.0001 [symbol] × [symbol] 0.5), wherein the sixth temperature ranges from 1200 [symbol] to 1700 [symbol] , and 1650 [symbol] is preferred. The operating time of the second reduction process ranges from 4 to 24 hours, and 12 hours is preferred. Furthermore, the environment for the second reduction process comprises mixed hydrogen and nitrogen or mixed hydrogen and argon.

### EXAMPLE 2

0.6274 g of BaO, 0.800 g of Eu₂O₃, 0.1833 g of MgO and 2.3173 g of Al₂O₃ are well mixed to form a mixture. [according to the molar ratio in (Ba_{0.9}Eu_{0.1})MgAl₁₀O₁₇]. Next, the mixture is milled and placed in a container made of aluminium oxide. Then, in an environment comprises mixed hydrogen and nitrogen or mixed hydrogen and argon, the mixture is heated to 1650 [symbol] , and a reduction process is performed to reduce the mixture for 12 hours, such that (Ba_{0.9}Eu_{0.1})MgAl₁₀O₁₇ is formed. After the reduction process, (Ba_{0.9}Eu_{0.1})MgAl₁₀O₁₇ is cooled to room temperature. Moreover, (Ba_{0.9}Eu_{0.1})MgAl₁₀O₁₇ is milled so as to obtain particles with uniformly size distribution.

The above-mentioned (Y_{2.95}Ce_{0.05})Al₅O₁₂ and (Ba_{0.9}Eu_{0.1})MgAl₁₀O₁₇ are mixed with proper portions to form a white lighting formula, and the formula can be driven at a low voltage.

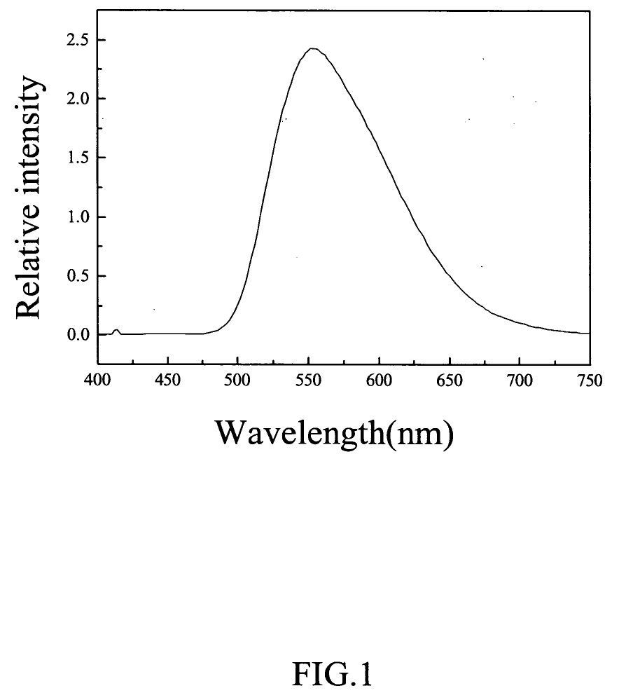

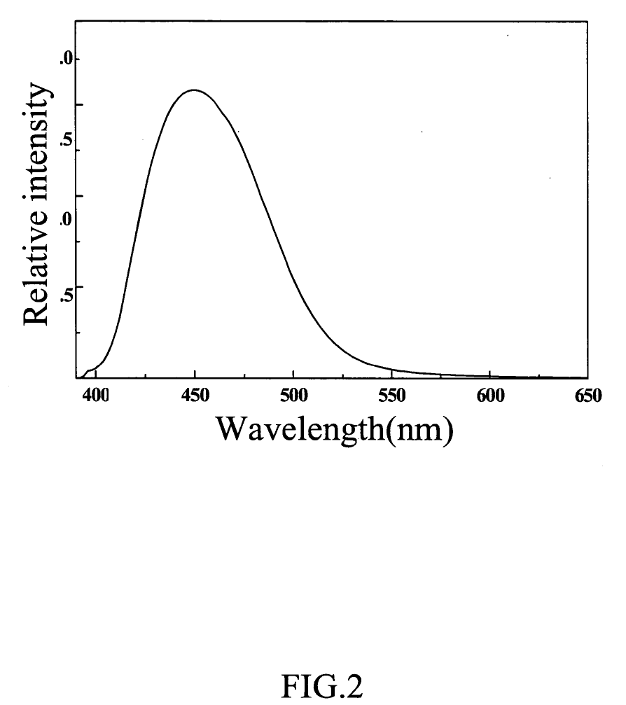

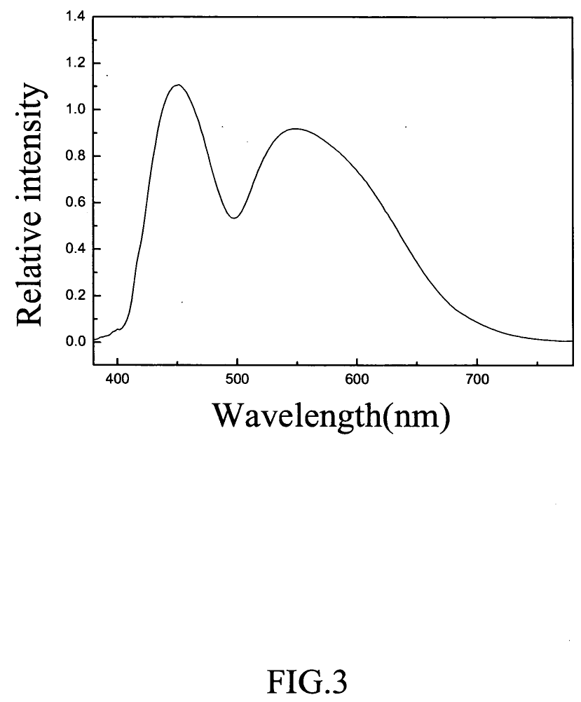

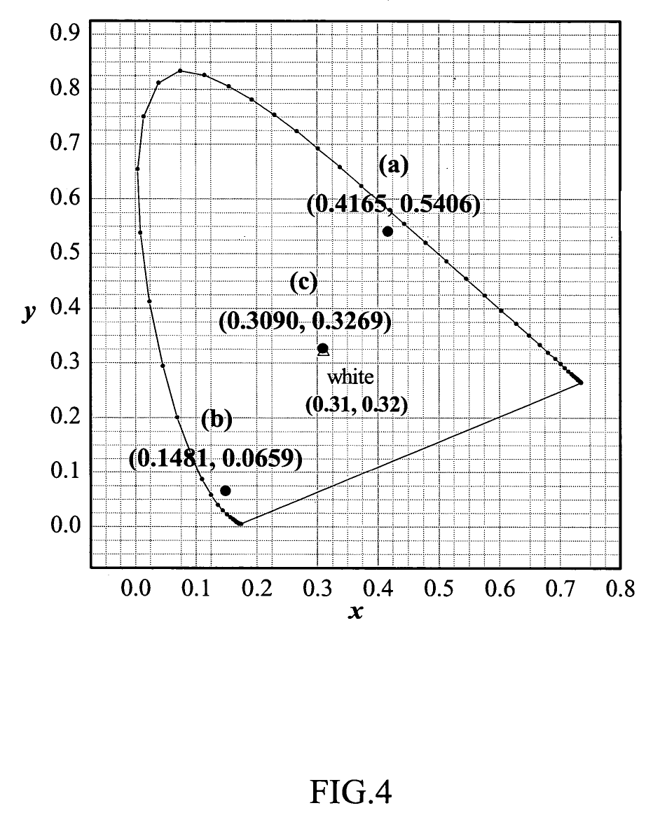

FIG. 1 and FIG. 2 are the emittion spectrums of (Y_{2.95}Ce_{0.05})Al₅O₁₂ and (Ba_{0.9}Eu_{0.1})MgAl₁₀O₁₇ respectively in accordance with the embodiment of this present invention. Referring to FIG. 1 and FIG. 2, (Y_{2.95}Ce_{0.05})Al₅O₁₂ is a fluorescent substance of yellow color, and (Ba_{0.9}Eu_{0.1})MgAl₁₀O₁₇ is a fluorescent substance of blue color. Next, as shown in FIG. 4, FIG. 1 and FIG. 2 are transformed to be shown on the chromaticity diagram according to the calculating formula established by Commission Internationale de l'Eclairage (CIE) in 1931. As shown in FIG. 4, there are two points (a) and (b), wherein (a) has the coordinate of x=0.4165, y=0.5406 indicating (Y_{2.95}Ce_{0.05})Al₅O₁₂, and (b) has the coordinate of x=0.1481, y=0.0659 indicating (Ba_{0.9}Eu_{0.1})MgAl₁₀O₁₇. On the other hand, FIG. 3 is the emittion spectrums of the white lighting formula which is composed of (Y_{2.95}Ce_{0.05})Al₅O₁₂ and (Ba_{0.9}Eu_{0.1})MgAl₁₀O₁₇ with proper portions. After similar calculation, FIG. 3 is then transformed to point (c) in FIG. 4, with the coordinate of x=0.3090, y=0.3269. Since this coordinate indicates white light, the formula is proved to emit white light, and the color rendering index thereof is 81.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A white lighting device, comprising:
a low voltage exciting source; and
at least two fluorescent substances exhibiting yellow and blue luminous colors after excited by said low voltage exciting source, wherein the host lattice of at least two said fluorescent substances is composed of alkaline earth metal and aluminium oxide, and said host lattice is further doped with activator; by mixing generated yellow and blue lights, a white light is then obtained;
in addition, the fluorescent substance exhibiting yellow color further absorbs a part of the blue ray emitted from the fluorescent substance exhibiting blue color, in an effort to obtain a stronger white light.

2. The device according to claim 1, wherein said low voltage exciting source is selected from a group consisting of the following: carbon nanotube emitter (CNT), surface conduction electron emitter (SED), ballistic electron surface emitter (BSD), metal insulator metal emitter (MIM) and the modifications thereof.

3. The device according to claim 1, wherein the working voltage of said low voltage exciting source is equal to or less than 1 kV.

4. The device according to claim 1, wherein said fluorescent substance exhibiting yellow luminous color is (Y₃₋ₓCeₓ)Al₅O₁₂ (0.0001 [symbol] × [symbol] 0.5), and said fluorescent substance exhibiting blue luminous color is (Ba₁₋ₓEuₓ)MgAl₁₀O₁₇ (0.0001 [symbol] × [symbol] 0.5).

5. The device according to claim 4, wherein a method for producing (Y₃₋ₓCeₓ)Al₅O₁₂ (0.0001 [symbol] × [symbol] 0.5) comprises:
mixing nitrates of yttrium, aluminum and cerium or oxides of yttrium, aluminum and cerium according to the wanted molar ratio in (Y₃₋ₓCeₓ)Al₅O₁₂ (0.0001 [symbol] × [symbol] 0.5) and forming a first mixture;
at a first temperature performing a calcination process to calcine said first mixture in the air, so as to form a second mixture;
at a second temperature performing a sintering process to sinter said second mixture in the air, so as to form a third mixture; and
at a third temperature performing a first reduction process to reduce said third mixture, so as to form said (Y₃₋ₓCeₓ)Al₅O₁₂ (0.0001 [symbol] × [symbol] 0.5).

6. The device according to claim 5, wherein the nitrates of yttrium, aluminum and cerium comprise Y(NO₃)₃ [symbol] 6H₂O, Al(NO₃)₃.9H₂O and Ce(NO₃)₃ [symbol] 6H₂O.

7. The device according to claim 5, wherein said first temperature is lower than 1100 [symbol] .

8. The device according to claim 5, wherein the operating time of said calcination process ranges from 20 to 30 hours.

9. The device according to claim 5, wherein said second temperature ranges from 1200 [symbol] to 1700 [symbol] .

10. The device according to claim 5, wherein the operating time of said sintering process ranges from 20 to 30 hours.

11. The device according to claim 5, wherein said third temperature ranges from 1200 [symbol] to 1700 [symbol] , and 1500 [symbol] is preferred.

12. The device according to claim 5, wherein the operating time of said first reduction process ranges from 4 to 24 hours, and 12 hours are preferred.

13. The device according to claim 5, wherein the environment for said reduction process comprises mixed hydrogen and nitrogen or mixed hydrogen and argon.

14. The device according to claim 1, wherein a preferred fluorescent substance exhibiting yellow luminous color is (Y_{2.95}Ce_{0.05})Al₅O₁₂.

15. The device according to claim 5, wherein said method for producing (Y₃₋ₓCeₓ)Al₅O₁₂ (0.0001 [symbol] × [symbol] 0.5), before said calcination process, further comprises:
dissolving said first mixture into an aqueous solution and forming a first solution;
adding a chelating agent to said first solution to chelate with metal ions and forming a second solution;
adding a alkaline compound to said second solution and forming a third solution, wherein said alkaline compound is to adjust the pH value of said third solution;
heating said third solution until it becomes sticky; and
at a fourth temperature performing a first pyrolysis process to remove most organic matters and a part of nitrogen oxides from said sticky third solution, so as to form a first solid matter for next calcination process.

16. The device according to claim 15, wherein said chelating agent further comprises citric acid.

17. The device according to claim 15, wherein said alkaline compound further comprises ethylenediamine.

18. The device according to claim 15, wherein the pH value of said third solution ranges from pH 5 to pH 10, and pH 7 is preferred.

19. The device according to claim 15, wherein said fourth temperature ranges from 450 [symbol] to 600 [symbol] .

20. The device according to claim 5, wherein said method for producing (Y₃₋ₓCeₓ)Al₅O₁₂ (0.0001 [symbol] × [symbol] 0.5), before said calcination process, further comprises:
dissolving said first mixture into an aqueous solution and forming a fourth solution;
adding a alkaline compound to said fourth solution and forming a sixth solution, wherein said alkaline compound is to adjust the pH value of said sixth solution, so as to produce a white gel;
performing a vacuum filtration process to proceed said sixth solution and obtaining said white gel; and
at a fifth temperature performing a second pyrolysis process to remove most organic matters and a part of nitrogen oxides from said white, so as to form a second solid matter for next calcination process.

21. The device according to claim 20, wherein said alkaline compound further comprises triethylamine.

22. The device according to claim 20, wherein the pH value of said sixth solution ranges from pH 3 to pH 11, and pH 10 to pH 11 is preferred.

23. The device according to claim 20, wherein said fifth temperature ranges from 450 [symbol] to 600 [symbol] .

24. The device according to claim 4, a method for producing (Ba₁₋ₓEuₓ)MgAl₁₀O₁₇ (0.0001 [symbol] × [symbol] 0.5) comprises:
mixing oxides of barium, europium, magnesium and aluminum according to the wanted molar ratio in (Ba₁₋ₓEuₓ)MgAl₁₀O₁₇ (0.0001 [symbol] × [symbol] 0.5) and forming a mixture;
at a sixth temperature performing a second reduction process to reduce said mixture, so as to form said (Ba₁₋ₓEuₓ)MgAl₁₀O₁₇ (0.0001 [symbol] × [symbol] 0.5).

25. The device according to claim 24, wherein the oxides of barium, europium, magnesium and aluminum comprise BaO, Eu₂O₃, MgO and Al₂O₃.

26. The device according to claim 24, wherein said sixth temperature ranges from 1200 [symbol] to 1700 [symbol] , and 1650 [symbol] is preferred.

27. The device according to claim 24, wherein the operating time of said second reduction process ranges from 4 to 24 hours, and 12 hours is preferred.

28. The device according to claim 24, wherein the environment for said second reduction process comprises mixed hydrogen and nitrogen or mixed hydrogen and argon.

29. The device according to claim 1, wherein a preferred fluorescent substance exhibiting blue luminous color is (Ba_{0.9}Eu_{0.1})MgAl₁₀O₁₇.
